(19) United States
(12) Patent Application Publication
(10) Pub. No.: US 2022/0250986 A1
(43) Pub. Date: Aug. 11, 2022

(54) USE OF AN ADDITIVE KIT IN 3D PRINTING OF A CONSTRUCTION MATERIAL COMPOSITION

(71) Applicant: BASF SE, Ludwigshafen am Rhein (DE)

(72) Inventors: Bernhard FEICHTENSCHLAGER, Trostberg (DE); Michael SCHINABECK, Trostberg (DE); Matthias Josef HOFMANN, Trostberg (DE)

(21) Appl. No.: 17/616,359

(22) PCT Filed: May 27, 2020
(86) PCT No.: PCT/EP2020/064643

§ 371 Date: Dec. 3, 2021

(30) Foreign Application Priority Data
Jun. 3, 2019 (EP) 19177887.7

(51) Int. Cl. C04B 28/04; C04B 40/00

(52) U.S. Cl. CPC C04B 28/04; C04B 2103/14; C04B 40/0039

(57) ABSTRACT

The present application relates to an additive component comprising a component A and a component B, wherein component A comprises at least one hardening retarder selected from glyoxylic acid, salts thereof, condensation or addition products of glyoxylic acid or salts thereof, and mixtures thereof, and component B comprises at least one hardening accelerator selected from calcium-silicate-hydrate, calcium formate, calcium nitrate, calcium chloride, calcium hydroxide, lithium carbonate, lithium sulfate, potassium sulfate, sodium sulfate, ground gypsum, and combinations thereof, in 3D printing of a construction material composition.

The present application relates to an additive component comprising a component A and a component B, wherein component A comprises at least one hardening retarder selected from glyoxylic acid, salts thereof, condensation or addition products of glyoxylic acid or salts thereof, and mixtures thereof, and component B comprises at least one hardening accelerator selected from calcium-silicate-hydrate, calcium formate, calcium nitrate, calcium chloride, calcium hydroxide, lithium carbonate, lithium sulfate, potassium sulfate, sodium sulfate, ground gypsum, aluminium salts, slurries of aluminate cements, and combinations thereof, in 3D printing of a construction material composition.

3D printing is a widely used technique to create three dimensional structures for various purposes. In 3D printing, 3D structures are produced by applying layers of material that are positions under computer control. The material is extruded in formable, viscous state through a nozzle and hardens quickly after deposition. Commonly used materials are thermoplastic polymers. 3D printing of inorganic material is more challenging than printing of polymers.

It is known in the art that two-component mortar systems may be used for printing 3D structures. As hardening must be accelerated upon applying the mortar system, a hardening accelerator is typically added upon application of the mortar with a 3D printing system, preferably by dosing the hardening accelerator to the mortar on the printing nozzle.

Typically, such two-component mortar systems are based on aluminate cements, as hydration can be inhibited by the use of set inhibitors during storage and extrusion in the 3D printer. A hardening accelerator may then be used to initiate setting during the application of the mortar with the 3D printer. However, such two-component mortar systems based on aluminate cements or aluminate salts are disadvantageous regarding the workability and durability. Furthermore, they are sensitive regarding the right temperature and water content. Moreover, aluminate cements are expensive and need high amounts of hydroxide and accelerator to initiate setting, which further increases costs and enhances the corrosiveness of the system.

In connection with mortars based on Portland cement, the problem arises that hydration typically occurs rapidly, so that a suspension of Portland cement in water cannot be extruded in formable, viscous state as required for 3D printing. On the other hand, a suitable accelerator for the hydration is needed, once the mortar has been applied.

WO 2018/083010 describes a multi-component mortar system comprising a component A and a component B wherein component A comprises aluminous cement, at least one set of inhibitor, at least one mineral filler and water, and component B comprises an initiator system for the set inhibited aluminous cement, at least one mineral filler and water. However, the content of aluminuous cement in the component A is preferably from 10 to 50% by weight.

Against this background, it was an object of the present invention to provide an additive kit, which is suitable for use in 3D printing of a construction material composition, wherein the construction material composition is preferably based on Portland cement. In particular, it was an object of the present application to provide an additive kit, which on the one hand ensures a good processability (workability) and a sufficient open time (time until initial setting) of the construction material composition during extrusion in the 3D printer, and on the other hand ensures rapid hardening, once the construction material has been applied with the 3D printer.

It has been found that these objects can be achieved by the use of an additive kit comprising a component A and a component B, wherein
component A comprises at least one hardening retarder selected from glyoxylic acid, salts thereof, condensation or addition products of glyoxylic acid or salts thereof, and mixtures thereof; and
component B comprises at least one hardening accelerator selected from calcium-silicate-hydrate, calcium carbonate, calcium amidosulfonate, calcium acetate, calcium citrate, calcium formate, calcium nitrate, calcium chloride, calcium hydroxide, lithium carbonate, lithium sulfate, potassium sulfate, sodium sulfate, ground gypsum, aluminium salts, slurries of aluminate cements, and combinations thereof;
   in 3D printing of a construction material composition.

It has surprisingly been found that if the kit according to the invention is used in 3D printing, component A and component B advantageously work in combination. When component A of the additive kit is used alone, it provides excellent workability and sufficient open times for the extrusion of a construction material composition in a 3D printer. Then, component B of the additive kit once added to the mixture of the construction material composition and component A, e.g., by dosing it to the mixture on the printer nozzle of the 3D printer, initiates rapid hardening. In particular, it has been found that the specific combination of component A and component B provides the advantage that component B immediately antagonizes the hardening retarding effect of component A of the additive kit and initiates hardening within a very short period of less than 20 minutes, while other combinations of retarder and accelerator do not allow for such a quick change in the hardening behavior.

Furthermore, the present invention relates to a process for producing a construction material 3D structure comprising the steps of
(i) mixing component A of the additive kit as defined above with a construction material composition as defined above, water, and optionally further components; and
(ii) hardening the mixture of step (i) by adding component B of the additive kit as defined above.

Moreover, the present invention relates to a construction material 3D structure obtainable by the above defined process.

The additive kit as used according to the present invention is described in further detail below.

The term “additive kit” as used herein refers to a combination of additives that is used in connection with 3D printing of the construction material composition as defined herein. The terms “kit” and “combination” are not intended to refer to a mixture of the two additives. Instead, the two additives will typically be used separately at different times, when used in 3D printing of a construction material composition. In particular, component A of the additive will typically be mixed with the construction material composition and water before the extrusion with the 3D printer, while component B will be added to said mixture only during the application of the mixture, e.g., by dosing it to the mixture on the printer nozzle. Thus, if the mixture, which is fed into the 3D printer and which comprises component A of the additive kit as well as the construction material composition and water, is considered to be one component of a mortar system, and component B of the additive considered to be another component of a mortar system, a two-component mortar system may be provided with the additive kit according to the present invention. This further illustrates that components A and B are used separately at different stages of the 3D printing process. In particular, component A will typically be present within the 3D printing machine, i.e. within the mixture being extruded, while component B will typically be dosed to said mixture only at the printer nozzle, i.e. outside the 3D printing machine.

Component A of the additive kit of the invention comprises at least one hardening retarder selected from glyoxylic acid, salts thereof, condensation or addition products of glyoxylic acid or salts thereof, and mixtures thereof.

Glyoxylic acid has the following structure:

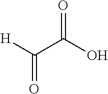

As used herein, salts of glyoxylic acid include the alkali, alkaline earth, zinc, iron, ammonium, and phosphonium salts of glyoxylic acid. As used herein, addition products of glyoxylic acid or salts thereof refer to products, which are obtainable by reacting a nucleophilic compound with the α-carbonyl group of glyoxylic acid, so as to obtain α-substituted α-hydroxy-acetic acid or a salt thereof as an adduct. As used herein, condensation products of glyoxylic acid or salts thereof refer to condensation products obtainable by reacting a compound containing at least one amino or amido group with the α-carbonyl group of glyoxylic acid, such that water is set free. Examples of compounds containing at least one amino or amido group include urea, thiourea, melamine, guanidine, acetoguanamine, benzoguanamine and other acyl-guanamines and polyacrylamide.

In one embodiment, the hardening retarder is glyoxylic acid or a salt thereof. Preferably, the hardening retarder is a compound A1 of the following formula:

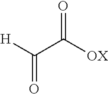

wherein X is selected from H or a cation equivalent Kₐ, wherein K is an alkali metal, alkaline earth metal, zinc, iron, ammonium, or a phosphonium cation, and wherein a is 1/n, wherein n is the valence of the cation. More preferably, X is H or Kₐ, wherein K is an alkali metal. Even more preferably K is lithium, sodium or potassium. It is to be understood that also mixed salts are possible. In a particularly preferred embodiment X is sodium or potassium or a mixture thereof.

In another embodiment, the hardening retarder is an addition product of glyoxylic acid or a salt thereof. Preferably, the hardening retarder is a compound A2 of the following formula:

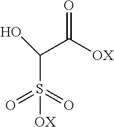

wherein X is in each case independently selected from H or a cation equivalent Kₐ, wherein K is an alkali metal, alkaline earth metal, zinc, iron, ammonium, or a phosphonium cation, and wherein a is 1/n, wherein n is the valence of the cation. More preferably, X is H or Kₐ, wherein K is an alkali metal. Even more preferably K is lithium, sodium or potassium. It is to be understood that also mixed salts are possible. In a particularly preferred embodiment X is independently sodium or potassium or a mixture thereof.

In yet another embodiment, the hardening retarder is a condensation product of glyoxylic acid or a salt thereof. Preferably, the hardening retarder is a compound A3 selected from the group consisting of a melamine-glyoxylic acid condensate, an urea-glyoxylic acid condensate, a melamine-urea-glyoxylic acid condensate and a polyacrylamide-glyoxylic acid condensate. Preferably, the amine-glyoxylic acid condensate is an urea-glyoxylic acid condensate.

The amine-glyoxylic acid condensates are obtainable by reacting glyoxylic acid with a compound containing aldehyde-reactive amino or amido groups. The glyoxylic acid can be used as an aqueous solution or as glyoxylic acid salts, preferably glyoxylic acid alkaline metal salts. Likewise, the amine compound can be used as salt, for example as guanidinium salts. In general, the amine compound and the glyoxylic acid are reacted in a molar ratio of 0.5 to 2 equivalents, preferably 1 to 1.3 equivalents, of glyoxylic acid per aldehyde-reactive amino or amido group. The reaction is carried out at a temperature of 0 to 12020 C., preferably 25 to 10520 C., most preferably 50 to 10520 C. The pH value is preferably from 0 to 8. The viscous products obtained in the reaction can be used as such, adjusted to a desired solids content by dilution or concentration or evaporated to dryness by, e.g., spray-drying, drum-drying, or flash-drying.

In general, the amine-glyoxylic acid condensates have molecular weights in the range of from 500 to 25000 g/mol, preferably 1000 to 10000 g/mol, particularly preferred 1000 to 5000 g/mol. The molecular weight is measured by the gel permeation chromatography method (GPC) as indicated in detail in the experimental part.

Thus, in one embodiment, the hardening retarder is selected from

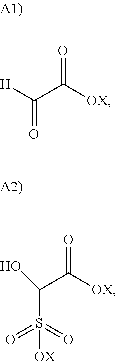

and
A3) an amine-glyoxylic acid condensate selected from the group consisting of a melamine-glyoxylic acid condensate, an urea-glyoxylic acid condensate, a melamine-urea-glyoxylic acid condensate and a polyacrylamide-glyoxylic acid condensate;
and mixtures thereof;
wherein X is in each case independently selected from H or a cation equivalent Kₐ,
wherein K is an alkali metal, alkaline earth metal, zinc, iron, ammonium, or a phosphonium cation, and wherein a is 1/n, wherein n is the valence of the cation.

In a preferred embodiment, the hardening retarder is selected from

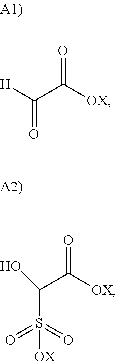

and
A3) an urea-glyoxylic acid condensate;
and mixtures thereof;
wherein X is in each case independently selected from H or a cation equivalent Kₐ,
wherein K is an alkali metal, alkaline earth metal, zinc, iron, ammonium, or a phosphonium cation, and wherein a is 1/n, wherein n is the valence of the cation,
and wherein preferably X is in each case independently selected from H and alkali metals, in particular from sodium, potassium, and mixtures thereof.

In a more preferred embodiment, X is H, Na, K, Li or a mixture thereof.

In one embodiment, component A of the additive kit of the invention further comprises at least one carbonate source, preferably an inorganic carbonate.

The carbonate source may be an inorganic carbonate having an aqueous solubility of 0.1 gL⁻¹ or more. The aqueous solubility of the inorganic carbonate is determined in water (starting at pH 7) at 2520 C. These characteristics are well known to those skilled in the art. The inorganic carbonate may be selected from alkaline metal carbonates such as potassium carbonate, sodium carbonate or lithium carbonate, and alkaline earth metal carbonates satisfying the required aqueous solubility, such as magnesium carbonate. It is also possible to use guanidine carbonate as an inorganic carbonate, as well as sodium hydrogencarbonate and potassium hydrogencarbonate.

Alternatively, the carbonate source is selected from organic carbonates. “Organic carbonate” denotes an ester of carbonic acid. The organic carbonate is hydrolyzed in the presence of the cementitious system to release carbonate ions. In an embodiment, the organic carbonate is selected from ethylene carbonate, propylene carbonate, glycerol carbonate, dimethyl carbonate, di(hydroxyethyl)carbonate or a mixture thereof, preferably ethylene carbonate, propylene carbonate, and glycerol carbonate or a mixture thereof, and in particular ethylene carbonate and/or propylene carbonate. Mixtures of inorganic carbonates and organic carbonates can as well be used.

In a preferred embodiment, the carbonate source is an inorganic carbonate. In a more preferred embodiment, the inorganic carbonate is selected from potassium carbonate, sodium carbonate, lithium carbonate, magnesium carbonate, and mixtures thereof, and is preferably sodium carbonate.

The weight ratio of hardening retarder to carbonate source is in general in the range from about 10:1 to about 1:100, preferably from about 5:1 to about 1:50 or about 1:1 to about 1:30, more preferably from about 1:1 to about 1:2.

In one embodiment, component A of the additive kit of the invention further comprises at least one hydroxylic acid or a salt or hydrate thereof. In a preferred embodiment, the hydroxylic acid or salt thereof is selected from citric acid, tartaric acid, gluconic acid, salts, hydrates, and combinations thereof, and is preferably trisodium citrate or a hydrate thereof, e.g. trisodium citrate dihydrate.

The weight ratio of hardening retarder to hydroxylic acid is preferably in the range of from about 30:1 to about 1:1, preferably from about 20:1 to about 5:1.

In one embodiment, component A of the additive kit of the invention further comprises at least one dispersant, which is selected from
comb polymers having a carbon-containing backbone to which are attached pendant cement-anchoring groups and polyether side chains,
non-ionic comb polymers having a carbon-containing backbone to which are attached pendant hydrolysable groups and polyether side chains, the hydrolysable groups upon hydrolysis releasing cement-anchoring groups,
sulfonated melamine-formaldehyde condensates,
lignosulfonates,
sulfonated ketone-formaldehyde condensates,
sulfonated naphthalene-formaldehyde condensates,
phosphonate containing dispersants, preferably the phosphonate containing dispersants comprise at least one polyalkylene glycol unit,
cationic (co)polymers, and
mixtures thereof.

In an embodiment, the dispersant is a comb polymer having a carbon-containing backbone to which are attached pendant cement-anchoring groups and polyether side chains. The cement-anchoring groups are anionic and/or anionogenic groups such as carboxylic groups, phosphonic or phosphoric acid groups or their anions. Anionogenic groups are the acid groups present in the polymeric dispersant, which can be transformed to the respective anionic group under alkaline conditions.

Preferably, the structural unit comprising anionic and/or anionogenic groups is one of the general formulae (Ia), (Ib), (Ic) and/or (Id):

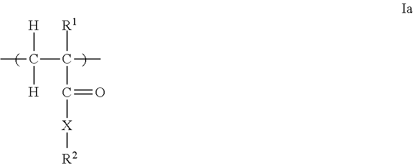

wherein
R¹ is H, C₁-C₄ alkyl, CH₂COOH or CH₂CO—X—R³, preferably H or methyl;
X is NH—(CₙH₂ₙ) or O—(CₙH₂ₙ) with n=1, 2, 3 or 4, or a chemical bond, the nitrogen atom or the oxygen atom being bonded to the CO group;
R² is PO₃M₂ or O—PO₃M₂; or, if X is not present, R² is OM;
R³ is PO₃M₂, or O—PO₃M₂;

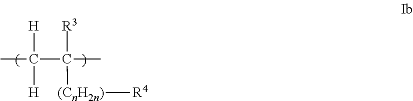

wherein
R³ is H or C₁-C₄ alkyl, preferably H or methyl;
n is 0, 1, 2, 3 or 4;
R⁴ is PO₃M₂, or O—PO₃M₂;

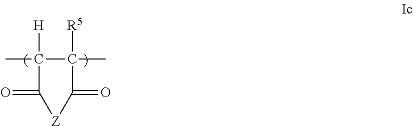

wherein
R⁵ is H or C₁-C₄ alkyl, preferably H;
Z is O or NR⁷;
R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂, and
n is 1, 2, 3 or 4;

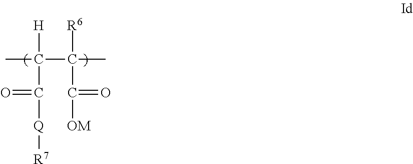

wherein
R⁶ is H or C₁-C₄ alkyl, preferably H;
Q is NR⁷ or O;
R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂,
n is 1, 2, 3 or 4; and
where each M independently is H or a cation equivalent.

Preferably, the structural unit comprising a polyether side chain is one of the general formulae (IIa), (IIb), (IIc) and/or (IId):

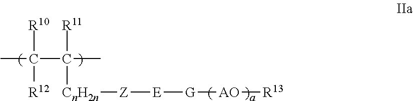

wherein
R¹⁰, R¹¹ and R¹² independently of one another are H or Ci-C4 alkyl, preferably H or methyl;
Z is 0 or S;
E is C₂-C₆ alkylene, cyclohexylene, CH₂-C₆H₁₀, 1,2-phenylene, 1,3-phenylene or 1,4-phenylene;
G is O, NH or CO—NH; or
E and G together are a chemical bond;
A is C₂-C₅ alkylene or CH₂CH(C₈H₅), preferably C₂-C₃ alkylene;
n is 0, 1, 2, 3, 4 or 5;
a is an integer from 2 to 350, preferably 10 to 150, more preferably 20 to 100;
R¹³ is H, an unbranched or branched C₁-C₄ alkyl group, CO—NH₂ or COCH₃;

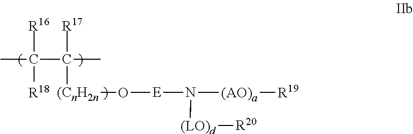

wherein
R¹⁶, R¹⁷ and R¹⁸ independently of one another are H or C₁-C₄ alkyl, preferably H;
E is C₂-C₆ alkylene, cyclohexylene, CH₂-C₆H₁₀, 1,2-phenylene, 1,3-phenylene, or 1,4-phenylene, or is a chemical bond;
A is C₂-C0₅ alkylene or CH₂CH(C₈H₅), preferably C₂-C₃ alkylene;
n is 0, 1, 2, 3, 4 and/or 5;
L is C₂-C₅ alkylene or CH₂CH(C₅H₅), preferably C₂-C₃ alkylene;
a is an integer from 2 to 350, preferably 10 to 150, more preferably 20 to 100;
d is an integer from 1 to 350, preferably 10 to 150, more preferably 20 to 100;
R¹⁹ is H or C₁-C₄ alkyl;
R²⁰ is H or C₁-C₄ alkyl; and
n is 0, 1, 2, 3, 4 or 5;

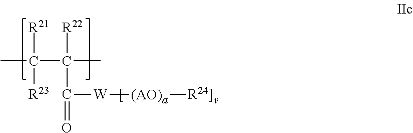

wherein
R²¹, R²² and R²³ independently are H or C₁-C₄ alkyl, preferably H;
W is O, NR²⁵, or is N;
V is 1 if W═O or NR²⁵, and is 2 if W═N;
A is C₂-C₅ alkylene or CH₂CH(C₆H₅), preferably C₂-C₃ alkylene;
a is an integer from 2 to 350, preferably 10 to 150, more preferably 20 to 100;
R²⁴ is H or C₁-C₄ alkyl;
R²⁵ is H or C₁-C₄ alkyl;

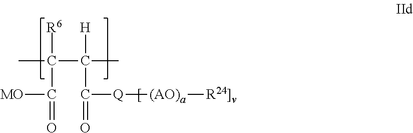

wherein
R⁶ is H or C₁-C0₄ alkyl, preferably H;
Q is NR¹⁰, N or O;
V is 1 if W═O or NR¹⁰ and is 2 if W═N;
R¹⁰ is H or C₁-C₄ alkyl;
A is C₂-C₅ alkylene or CH₂CH(C₆H₅), preferably C₂-C₃ alkylene; and
a is an integer from 2 to 350, preferably 10 to 150, more preferably 20 to 100.

The molar ratio of structural units (I) to structural units (II) varies from 1/3 to about 10/1, preferably 1/1 to 10/1, more preferably 3/1 to 6/1. The polymeric dispersants comprising structural units (I) and (II) can be prepared by conventional methods, for example by free radical polymerization. The preparation of the dispersants is, for example, described in EP0894811, EP1851256, EP2463314, and EP0753488.

More preferably, the dispersant is selected from the group of polycarboxylate ethers (PCEs). In PCEs, the anionic groups are carboxylic groups and/or carboxylate groups. The PCE is preferably obtainable by radical copolymerization of a polyether macromonomer and a monomer comprising anionic and/or anionogenic groups. Preferably, at least 45 mol-%, preferably at least 80 mol-% of all structural units constituting the copolymer are structural units of the polyether macromonomer or the monomer comprising anionic and/or anionogenic groups.

A further class of suitable comb polymers having a carbon-containing backbone to which are attached pendant cement-anchoring groups and polyether side chains comprise structural units (III) and (IV):

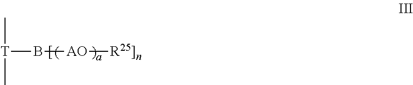

wherein
T is phenyl, naphthyl or heteroaryl having 5 to 10 ring atoms, of which 1 or 2 atoms are heteroatoms selected from N, O and S;
n is 1 or 2;
B is N, NH or O, with the proviso that n is 2 if B is N and n is 1 if B is NH or O;
A is an C₂-C₅ alkylene or CH₂CH(C₆H₅);
a is an integer from 1 to 300;
R²⁵ is H, C₁-C₁₀ alkyl, C₅-C₈ cycloalkyl, aryl, or heteroaryl having 5 to 10 ring atoms, of which 1 or 2 atoms are heteroatoms selected from N, O and S;
   where the structural unit (IV) is selected from the structural units (IVa) and (IVb):

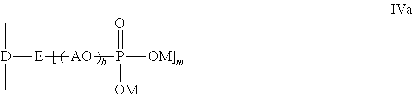

wherein
D is phenyl, naphthyl or heteroaryl having 5 to 10 ring atoms, of which 1 or 2 atoms are heteroatoms selected from N, O and S;
E is N, NH or O, with the proviso that m is 2 if E is N and m is 1 if E is NH or O;
A is C₂-C₅ alkylene or CH₂CH(C₆H₅);
b is an integer from 0 to 300;
M independently is H or a cation equivalent;

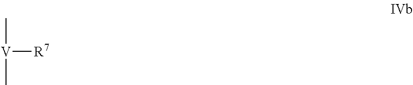

wherein
V is phenyl or naphthyl and is optionally substituted by 1 to 4 radicals, preferably two radicals selected from R⁸, OH, OR⁸, (CO)R⁸, COOM, COOR⁸, SO₃R⁸ and NO₂;
R¹ is COOM, OCH₂COOM, SO₃M or OPO₃M₂;
M is H or a cation equivalent; and
R⁸ is C₁-C₄ alkyl, phenyl, naphthyl, phenyl-C₁-C₄ alkyl or C₁-C₄ alkylphenyl.

Polymers comprising structural units (III) and (IV) products are obtainable by polycondensation of an aromatic or heteroaromatic compound having a polyoxyalkylene group attached to the aromatic or heteroaromatic core, an aromatic compound having a carboxylic, sulfonic or phosphate moiety, and an aldehyde compound such as formaldehyde.

In an embodiment, the dispersant is a non-ionic comb polymer having a carbon-containing backbone to which are attached pendant hydrolysable groups and polyether side chains, the hydrolysable groups upon hydrolysis releasing cement-anchoring groups. Conveniently, the structural unit comprising a polyether side chain is one of the general formulae (IIa), (IIb), (IIc) and/or (IId) discussed above. The structural unit having pendant hydrolysable groups is preferably derived from acrylic acid ester monomers, more preferably hydroxyalkyl acrylic monoesters and/or hydroxyalkyl diesters, most preferably hydroxypropyl acrylate and/or hydroxyethyl acrylate. The ester functionality will hydrolyze to acid groups upon exposure to water, and the resulting acid functional groups will then form complexes with the cement component.

In certain embodiment, the non-ionic comb polymer is represented by the following general formula I

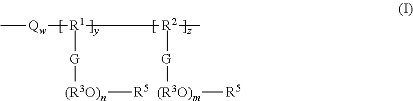

wherein Q is a Component A ethylenically unsaturated monomer comprising a hydrolysable moiety; G comprises O, C(O) O, or O—(CH₂)ₚ—O where p=2 to 8, and wherein mixtures of G are possible in the same polymer molecule; R¹ and R² each independently comprise at least one C₂-C₈ alkyl; R³ comprises (CH₂)_{c} wherein each c is a numeral from 2 to about 5 and wherein mixtures of R³ are possible in the same polymer molecule; each R⁵ comprises at least one of H, a C₁₋₂₀ (linear or branched, saturated or unsaturated) aliphatic hydrocarbon radical, a C₅₋₈ cycloaliphatic hydrocarbon radical, or a substituted or unsubstituted C₆₋₁₄ aryl radical; m=1 to 30, n=31 to about 350, w=about 1 to about 10, y=0 to about 1, and z=0 to about 1; and wherein y+z is greater than 0 to about 1 and w is less than or equal to 10 times the sum of y+z.

In particular embodiments, the non-ionic comb polymer is represented by the following general formula (II):

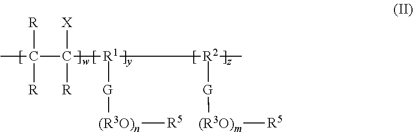

wherein G comprises O, C(O)—O, or O—(CH₂)ₚ—O where p=2 to 8, and wherein mixtures of G are possible in the same polymer molecule; R comprises at least one of H or CH₃; R¹ and R² each independently comprise at least one C₂-C₈ alkyl; R³ comprises (CH₂)_{c} wherein each c is a numeral from 2 to about 5 and wherein mixtures of R³ are possible in the same polymer molecule; X comprises a hydrolysable moiety; each R⁵ comprises at least one of H, a C₁₋₂₀ (linear or branched, saturated or unsaturated) aliphatic hydrocarbon radical, a C₅₋₈ cycloaliphatic hydrocarbon radical, or a substituted or unsubstituted C₆₋₁₄ aryl radical; m=1 to 30, n=31 to about 350, w=about 1 to about 10, y=0 to about 1, and z=0 to about 1; and wherein y+z is greater than 0 to about 1 and w is less than or equal to 10 times the sum of y+z. According to this formula, in certain embodiments, the hydrolysable moiety may comprise at least one of alkyl ester, amino alkyl ester, hydroxyalkyl ester, amino hydroxyalkyl ester, or amide such as acrylamide, methacrylamide, and their derivatives.

In specific embodiments, the non-ionic comb polymer is represented by the following general formula (III):

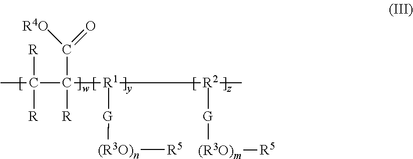

wherein G comprises O, C(O)—O, or O—(CH₂)p-O where p=2 to 8, and wherein mixtures of G are possible in the same polymer molecule; R comprises at least one of H or CH₃; R¹ and R² each independently comprise at least one C₂-C₈ alkyl; R³ comprises (CH₂)_{c} wherein each c is a numeral from 2 to about 5 and wherein mixtures of R³ are possible in the same polymer molecule; R⁴ comprises at least one of C₁₋₂₀ alkyl or C₂₋₂₀ hydroxyalkyl; each R⁵ comprises at least one of H, a C₁₋₂₀ (linear or branched, saturated or unsaturated) aliphatic hydrocarbon radical, a C₆₋₈ cycloaliphatic hydrocarbon radical, or a substituted or unsubstituted C₆₋₁₄ aryl radical; m=1 to 30, n=31 to about 350, w=about 1 to about 10, y=0 to about 1, and z=0 to about 1; and wherein y+z is greater than 0 to about 1 and w is less than or equal to 10 times the sum of y+z. According to this formula, in certain embodiments, a non-ionic copolymer may be used wherein each p is 4; each R⁴ comprises C₂H₄OH or C₃H₆OH; each R⁵ comprises H; m=about 5 to 30, n=31 to about 250, w=about 1 to about 9, y=0 to about 1, and z=0 to about 1; and wherein y+z is greater than 0 to about 1, and w is less than or equal to 9 times the sum of y+z.

Such non-ionic comb polymers are described in WO 2009/153202. Further non-ionic comb polymers are described in WO 2006/042709 and WO 2010/040612.

Suitable sulfonated melamine-formaldehyde condensates are of the kind frequently used as plasticizers for hydraulic binders (also referred to as MFS resins). Sulfonated melamine-formaldehyde condensates and their preparation are described in, for example, CA 2 172 004 A1, DE 44 1 1 797 A1, U.S. Pat. Nos. 4,430,469, 6,555,683 and CH 686 186 and also in Ullmann's Encyclopedia of Industrial Chemistry, 5th Ed., vol. A2, page 131, and Concrete Admixtures Handbook-Properties, Science and Technology, 2. Ed., pages 411, 412. Preferred sulfonated melamine-sulfonate-formaldehyde condensates encompass (greatly simplified and idealized) units of the formula

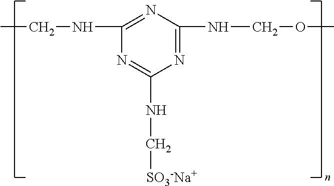

in which n stands generally for 10 to 300. The molar weight is situated preferably in the range from 2500 to 80 000. Additionally to the sulfonated melamine units it is possible for other monomers to be incorporated by condensation. Particularly suitable is urea. Moreover, further aromatic units as well may be incorporated by condensation, such as gallic acid, aminobenzenesulfonic acid, sulfanilic acid, phenolsulfonic acid, aniline, ammoniobenzoic acid, dialkoxybenzene-sulfonic acid, dialkoxybenzoic acid, pyridine, pyridinemonosulfonic acid, pyridinedisulfonic acid, pyridinecarboxylic acid and pyridinedicarboxylic acid. An example of melaminesulfonate-formaldehyde condensates are the Melment® products distributed by BASF Construction Solutions GmbH.

Suitable lignosulfonates are products which are obtained as by-products in the paper industry. They are described in Ullmann's Encyclopedia of Industrial Chemistry, 5th Ed., vol. A8, pages 586, 587. They include units of the highly simplified and idealizing formula

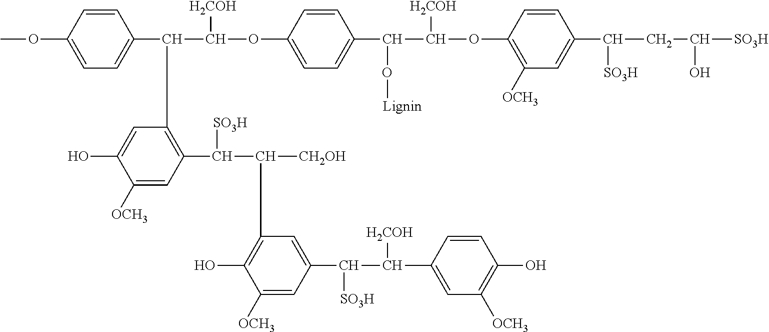

where n stands generally for 5 to 500. Lignosulfonates have molar weights of between 2000 and 100 000 g/mol. In general, they are present in the form of their sodium, calcium and/or magnesium salts. Examples of suitable lignosulfonates are the Borresperse products distributed by Borregaard LignoTech, Norway.

Suitable sulfonated ketone-formaldehyde condensates are products incorporating a mono-ketone or diketone as ketone component, preferably acetone, butanone, pentanone, hexanone or cyclohexanone. Condensates of this kind are known and are described in WO 2009/103579, for example. Sulfonated acetone-formaldehyde condensates are preferred. They generally comprise units of the formula (according to J. Plank et al., J. Appl. Poly. Sci. 2009, 2018-2024:

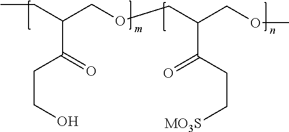

where m and n are generally each 10 to 250, M is an alkali metal ion, such as Na+, and the ratio m:n is in general in the range from about 3:1 to about 1:3, more particularly about 1.2:1 to 1:1.2. Furthermore, it is also possible for other aromatic units to be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. Examples of suitable acetone-formaldehyde condensates are the Melcret K1L products distributed by BASF Construction Solutions GmbH.

Suitable sulfonated naphthalene-formaldehyde condensates are products obtained by sulfonation of naphthalene and subsequent polycondensation with formaldehyde. They are described in references including Concrete Admixtures Handbook-Properties, Science and Technology, 2. Ed., pages 411 -413 and in Ullmann's Encyclopedia of Industrial Chemistry, 5th Ed., vol. A8, pages 587, 588. They comprise units of the formula

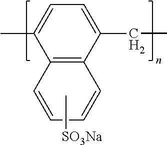

Typically, molar weights (Mw) of between 1000 and 50 000 g/mol are obtained. Furthermore, it is also possible for other aromatic units to be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. Examples of suitable β-naphthalene-formaldehyde condensates are the Melcret 500 L products distributed by BASF Construction Solutions GmbH.

Generally, phosphonate containing dispersants incorporate phosphonate groups and polyether side groups.

Suitable phosphonate containing dispersants are those according to the following formula

R—(OA)ₙ-N—[CH₂—PO(OM₂)₂]₂

wherein
R is H or a hydrocarbon residue, preferably a C₁-C₁₅ alkyl radical,
A is independently C₂-C₁₈ alkylene, preferably ethylene and/or propylene, most preferably ethylene,
n is an integer from 5 to 500, preferably 10 to 200, most preferably 10 to 100, and
M is H, an alkali metal, 1/2 earth alkali metal and/or an amine.

Useful as dispersant are also cationic (co)polymers. The cationic (co)polymers comprise preferably
a) 3 to 100 mol-%, preferably 10 to 90 mol %, more preferably 25 to 75 mol % of a cationic structural unit of formula (V)

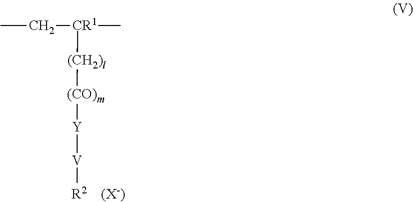

wherein
R¹ in each occurrence is the same or different and represents hydrogen and/or methyl,
R² in each occurrence is the same or different and is selected from the group consisting of:

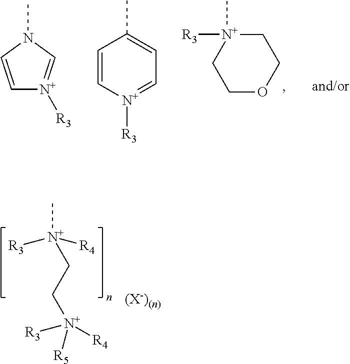

wherein
R³, R⁴ and R⁵ in each occurrence are the same or different and each independently represent hydrogen, an aliphatic hydrocarbon moiety having 1 to 20 carbon atoms, a cycloaliphatic hydrocarbon moiety having 5 to 8 carbon atoms, aryl having 6 to 14 carbon atoms and/or a polyethylene glycol (PEG) moiety,
I in each occurrence is the same or different and represents an integer from 0 to 2,
m in each occurrence is the same or different and represents 0 or 1,
n in each occurrence is the same or different and represents an integer from 0 to 10,
Y in each occurrence is the same or different and represents an absent group, oxygen, NH and/or NR³,
V in each occurrence is the same or different and represents —(CH₂)ₓ—,

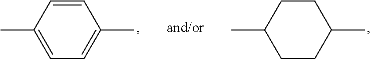

wherein
x in each occurrence is the same or different and represents an integer from 0 to 6, and
(X⁻) in each occurrence is the same or different and represents a halogenide ion, a C₁₋₄-alkyl sulfate, a C₁₋₄-alkyl sulfonate, a C₆₋₁₄-(alk)aryl sulfonate and/or a monovalent equivalent of a polyvalent anion, which is selected from a sulfate, a disulfate, a phosphate, a diphosphate, a tri phosphate and/or a polyphosphate.

Preferably the cationic (co)polymers comprises
b) from 0 to 97 mol-%, preferably 10 to 90 mol %, more preferably 25 to 75 mol %, of a macromonomeric structural unit of formula (VI)

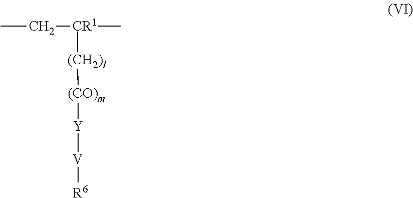

wherein
R⁶ in each occurrence is the same or different and represents a polyoxyalkylene group of the following formula (VII)

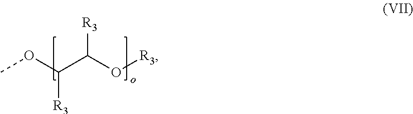

wherein
o in each occurrence is the same or different and represents an integer from 1 to 300, and
R¹, R³, I, m, Y, V, and x have the meanings given above,
provided that, in both structural units (V) and (VI), Y represents an absent group when x is=0.

Preferably in the cationic (co)polymer the monomer components corresponding to the structural unit (V) are selected from quaternized N-vinylimidazole, quaternized N-allylimidazole, quaternized 4-vinylpyridine, quaternized 1-[2-(acryloyloxy)ethyl]-1H-imidazole, 1-[2-(methacryloyloxy)ethyl]-1H-imidazole, and mixtures thereof.

Preferably in the cationic (co)polymer the monomer components corresponding to the structural unit (VI) are selected from vinyl ethers, vinyloxy C₁₋₆-alkyl ethers, in particular vinyloxy butyl ethers, allyl ethers, methallyl ethers, 3-butenyl ethers, isoprenyl ethers, acrylic esters, meth-acrylic esters, acrylamides, methacrylamides, and mixtures thereof.

In the cationic (co)polymer o is preferably from 5 to 300, more preferably 10 to 200, and in particular 20 to 100.

In the cationic (co)polymer the oxyalkylene units of the polyoxyalkylene group of formula (VII) are preferably selected from ethylene oxide groups and/or propylene oxide groups, which are arranged randomly, alternatingly, graduatedly and/or blockwise within the polyoxyalkylene group.

The cationic (co)polymer is preferably characterized in that the polyoxyalkylene group of formula (VII) is a mixture with different values for o within the specified definition.

Preferable is the cationic (co)polymer comprising 10 to 90 mol-% of the cationic structural unit and 90 to 10 mol-% of the macromonomeric structural unit, preferably 25 to 75 mol-% of the cationic structural unit and 75 to 25 mol-% of the macromonomeric structural unit.

Preferably, the cationic (co)polymer has a molecular weight in the range of from 1000 to 500000, more preferably 2000 to 150000 and in particular 4000 to 100000 g/mol. Preferably, the molecular weight is determined by the gel permeation chromatography method (GPC) as indicated in the experimental part.

The cationic (co)polymers are particularly useful for dispersing aqueous suspensions of binders selected from the group comprising hydraulic binders and/or latent hydraulic binders. The latent hydraulic binder is preferably blast furnace slag.

Component B of the additive kit of the invention comprises at least one hardening accelerator selected from calcium-silicate-hydrate, calcium carbonate, calcium amidosulfonate, calcium acetate, calcium citrate, calcium formate, calcium nitrate, calcium chloride, calcium hydroxide, lithium carbonate, lithium sulfate, potassium sulfate, sodium sulfate, ground gypsum, aluminium salts such as sodium aluminate, potassium aluminate, and aluminum sulfate, slurries of aluminate cements, and combinations thereof.

In one embodiment, the at least one hardening accelerator is selected from calcium-silicate-hydrate, calcium carbonate, calcium amidosulfonate, calcium acetate, calcium citrate, calcium formate, calcium nitrate, calcium chloride, calcium hydroxide, lithium carbonate, lithium sulfate, potassium sulfate, sodium sulfate, ground gypsum, and combinations thereof.

In one embodiment, the at least one hardening accelerator is selected from calcium-silicate-hydrate, calcium hydroxide, and combinations thereof.

A particularly preferred hardening accelerator is a calcium-silicate-hydrate (C—S—H). The calcium-silicate-hydrate may contain foreign ions, such as magnesium and aluminium. The calcium-silicate-hydrate can be preferably described with regard to its composition by the following empirical formula:

a CaO, SiO₂, b Al₂O₃, c H₂O, d X, e W

X is an alkali metal

W is an alkaline earth metal

| | | |
|---|---|---|
| 0.1 ≤ a ≤ 2 | preferably | 0.66 ≤ a ≤ 1.8 |
| 0 ≤ b ≤ 1 | preferably | 0 ≤ b ≤ 0.1 |
| 1 ≤ c ≤ 6 | preferably | 1 ≤ c ≤ 6.0 |
| 0 ≤ d ≤ 1 | preferably | 0 ≤ d ≤ 0.4 or 0.2 |
| 0 ≤ e ≤ 2 | preferably | 0 ≤ e ≤ 0.1 |

Calcium-silicate-hydrate can be obtained preferably by reaction of a calcium compound with a silicate compound, preferably in the presence of a polycarboxylate ether (PCE). Such products containing calcium-silicate-hydrate are for example described in WO 2010/026155 A1, EP 14198721, WO 2014/114784 or WO 2014/114782.

C—S—H may be provided, e.g., as low-density CSH, CSH gel, or CSH seeds. CSH seeds having an average diameter of less the 10 μm, preferably less than 1 μm are preferred.

The water content of the calcium-silicate-hydrate based hardening accelerator in powder form is preferably from 0.1 weight % to 5.5 weight % with respect to the total weight of the powder sample. Said water content is measured by putting a sample into a drying chamber at 8020 C. until the weight of the sample becomes constant. The difference in weight of the sample before and after the drying treatment is the weight of water contained in the sample. The water content (%) is calculated as the weight of water contained in the sample divided with the weight of the sample.

The calcium-silicate-hydrate may preferably be provided as an aqueous suspension. The water content of the aqueous suspension is preferably from 10 weight % to 95 weight %, preferably from 40 weight % to 90 weight %, more preferably from 50 weight % to 85 weight %, in each case the percentage is given with respect to the total weight of the aqueous suspension sample. The water content is determined in an analogous way as described in the before standing text by use of a drying chamber.

Another preferred hardening accelerator is calcium hydroxide.

In a particularly preferred embodiment, calcium-silicate-hydrate and calcium hydroxide may be used in combination. The weight ratio of C—S—H to Ca(OH)₂ may preferably be from 1:50 to 10:50, particularly preferably from 1:20 to 5:20.

Particularly preferably, the hardening accelerator of component B is provided as seeds having an average diameter of less the 10 μm, preferably less than 1 μm.

In a preferred embodiment of the invention, component B of the additive kit is provided in the form of a slurry, e.g. an aqueous slurry. The slurry preferably comprises from 0.1 to 20% by weight of the hardening accelerator. Optionally, further components may be present in the slurry.

In one embodiment, component B of the additive kit of the invention further comprises at least one polyhydroxy compound or salts or esters thereof.

As used herein, the term polyhydroxy compound refers to an organic compound comprising at least two, preferably at least three hydroxy groups. The carbon chain of the compound may be linear or cyclic. Preferably the polyhydroxy compound only comprises carbon, oxygen, hydrogen, and optionally nitrogen atoms.

In a preferred embodiment, the polyhydroxy compound is selected from polyalcohols with a carbon to oxygen ratio of C/O≥1, preferably from C/O≥1 to C/O≥1.5, more preferably from C/O≥1 to C/O≤1.25, and mixtures thereof.

In another preferred embodiment, the polyhydroxy compound has a molecular weight of from 62 g/mol to 25000 g/mol, preferably from 62 g/mol to 10000 g/mol and most preferably from 62 g/mol to 1000 g/mol.

In another preferred embodiment, the polyhydroxy compound is selected from sugar alcohols and their condensation products, alkanolamines and their condensation products, carbohydrates, pentaerythritol, trimethylolpropane, and mixture thereof.

As used herein, sugar alcohols preferably include sugar alcohols based on C₃-C₁₂-sugar molecules. Preferred sugar alcohols include glycerol, threitol, erythritol, xylitol, sorbitol, inositol, mannitol, maltitol, and lactitol. A particularly preferred sugar alcohol is glycerol having the following formula:

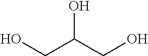

As used herein, the term alkanolamines refers to polyhydroxy compounds comprising at least one amino group. Exemplary alkanolamines include diethanolamine, methyl diethanolamine, butyl diethanolamine, monoisopropanolamine, diisopropanolamine, methyl diisopropanolamine, triethanolamine, tetrahydroxypropylethylenediamine, trimethylaminoethylethanolamine, N,N-bis(2-hydroxyethyl)isopropanolamine, N,N,N′-trimethylaminoethylethanolamine, and N,N,N′,N′-tetrakis(2-hydroxypropyl)ethylenediamine.

As used herein, the term carbohydrate refers to sugars, starch, and cellulose. Preferably, the term carbohydrate is intended to refer to sugars, i.e. mono- and disaccharides. Preferred carbohydrates according to the invention include glucose, fructose, sucrose, and lactose.

In a more preferred embodiment of the invention, the polyhydroxy compound is selected from glycerol, threitol, erythritol, xylitol, sorbitol, inositol, mannitol, maltitol, lactitol, pentaerythritol, trimethylolpropane, and mixture thereof. In a particularly preferred embodiment, the polyhydroxy compound is glycerol.

As indicated above, the polyhydroxy compound may also be used in the form of the salt or ester thereof.

Suitable salts include metal salts such as alkali metal, alkaline earth metal, zinc, and iron salts, ammonium salts, and phosphonium salts. Preferred are metal salts, in particular alkali metal salts.

Suitable esters include saturated or unsaturated C₁-C₂₀-carboxylic acid esters, preferably C₂-C₁₀-carboxylic acid esters, such as acetic acid esters. The carboxylic acid moiety may be unsubstituted or substituted by one or more substituents selected from halogen, OH, and ═O.

The weight ratio of hardening accelerator to polyhydroxy compound may be from 1:50 to 2:1, preferably from 1:30 to 1:1.

As indicated above, the additive kit according to the invention as defined above is used in 3D printing of a construction material composition. The dosage of component A of the additive kit in dry form relative to the construction material in weight % of the construction material composition is preferably from 0.01 to 5%. The dosage of component B of the additive kit in dry form relative to the construction material in weight % of the construction material composition is preferably from 0.05 to 10%.

In one embodiment, the construction material composition comprises at least one inorganic binder.

The inorganic binder may be a hydraulic binder, a latent hydraulic binder, a calcium sulfate based binder, or a mixture thereof.

In a preferred embodiment, the at least one inorganic binder is a hydraulic binder, which is preferably selected from Portland cement, calcium aluminate cement, sulfoaluminate cement, and mixtures thereof, and is particularly preferably Portland cement. In certain preferred embodiment, the inorganic binder comprises aluminate cements in an amount of less than 10% by weight, preferably less than 5% by weight. In certain particularly preferred embodiments, the construction material composition is free of aluminate cements.

The mineralogical phases are indicated by their usual name followed by their cement notation. The primary compounds are represented in the cement notation by the oxide varieties: C for CaO, S for SiO₂, A for Al₂O₃, $ for SO₃, H for H₂O; this notation is used throughout.

The term “Portland cement” denotes any cement compound containing Portland clinker, especially CEM I, II, III, IV and V within the meaning of standard EN 197-1, paragraph 5.2. A preferred cement is ordinary Portland cement (OPC) according to DIN EN 197-1 which may either contain calcium sulfate (<7% by weight) or is essentially free of calcium sulfate (<1% by weight).

Calcium aluminate cement (also referred to as high aluminate cement) means a cement containing calcium aluminate phases. The term “aluminate phase” denotes any mineralogical phase resulting from the combination of aluminate (of chemical formula Al₂O₃, or “A” in cement notation), with other mineral species. The amount of alumina (in form of Al₂O₃) is 30% by weight of the total mass of the aluminate-containing cement as determined by means of X-ray fluorescence (XRF). More precisely, said mineralogical phase of aluminate type comprises tricalcium aluminate (C₃A), monocalcium aluminate (CA), mayenite (C₁₂A₇), tetracalcium aluminoferrite (C₄AF), or a combination of several of these phases.

Sulfoaluminate cement has a content of yeelimite (of chemical formula 4CaO.3Al₂O₃.SO₃ or C₄A₃$ in cement notation) of greater than 15% by weight.

In one preferred embodiment, the inorganic binder is a hydraulic binder, which is selected from Portland cement, calcium aluminate cement, sulfoaluminate cement, and mixtures thereof. In another preferred embodiment, the inorganic binder comprises a mixture of Portland cement and aluminate cement, or a mixture of Portland cement and sulfoaluminate cement or a mixture of Portland cement, aluminate cement and sulfoaluminate cement.

In an embodiment, where the construction chemical composition contains an aluminate-containing cement, the compositions may additionally contain at least one sulfate source, preferably calcium sulfate source. The calcium sulfate source may be selected from calcium sulfate dihydrate, anhydrite, α- and β-hemihydrate, i.e. α-bassanite and β-bassanite, or mixtures thereof. Preferably the calcium sulfate is α-bassanite and/or p-bassanite. In general, calcium sulfate is comprised in an amount of about 1 to about 20 weight %, based on the weight of the aluminate-containing cement. In a further embodiment, the construction chemical composition additionally contains at least one alkali metal sulfate like potassium sulfate or sodium sulfate, or aluminum sulfate.

Preferable are construction material compositions, which comprise a hydraulic binder and in which the weight percentage of sulfate with respect to the weight of clinker is from 4 to 14 weight %, preferably from 8 to 14 weight % most preferably from 9 to 13 weight %. The mass of sulfate is to be understood as the mass of the sulfate ion without the counterion. Preferably the sulfate is present in the form of calcium sulfate, more preferably in the form of α-bassanite and/or β-bassanite.

Addition of sulphate to hydraulic binders (cements), which are poor in the contents of sulphate helps to encourage the formation of ettringite and leads to a better early strength development.

The construction chemical compositions or building material formulations may also contain latent hydraulic binders and/or pozzolanic binders. For the purposes of the present invention, a “latent hydraulic binder” is preferably a binder in which the molar ratio (CaO+MgO):SiO₂ is from 0.8 to 2.5 and particularly from 1.0 to 2.0. In general terms, the above-mentioned latent hydraulic binders can be selected from industrial and/or synthetic slag, in particular from blast furnace slag, electrothermal phosphorous slag, steel slag and mixtures thereof. The “pozzolanic binders” can generally be selected from amorphous silica, preferably precipitated silica, fumed silica and microsilica, ground glass, metakaolin, aluminosilicates, fly ash, preferably brown-coal fly ash and hard-coal fly ash, natural pozzolans such as tuff, trass and volcanic ash, natural and synthetic zeolites and mixtures thereof.

The slag can be either industrial slag, i.e. waste products from industrial processes, or else synthetic slag. The latter can be advantageous because industrial slag is not always available in consistent quantity and quality.

Blast furnace slag (BFS) is a waste product of the glass furnace process. Other materials are granulated blast furnace slag (GBFS) and ground granulated blast furnace slag (GGBFS), which is granulated blast furnace slag that has been finely pulverized. Ground granulated blast furnace slag varies in terms of grinding fineness and grain size distribution, which depend on origin and treatment method, and grinding fineness influences reactivity here. The Blaine value is used as parameter for grinding fineness, and typically has an order of magnitude of from 200 to 1000 m² kg⁻¹, preferably from 300 to 600 m² kg⁻¹. Finer milling gives higher reactivity.

For the purposes of the present invention, the expression “blast furnace slag” is however intended to comprise materials resulting from all of the levels of treatment, milling, and quality mentioned (i.e. BFS, GBFS and GGBFS). Blast furnace slag generally comprises from 30 to 45% by weight of CaO, about 4 to 17% by weight of MgO, about 30 to 45% by weight of SiO₂ and about 5 to 15% by weight of A1₂0₃, typically about 40% by weight of CaO, about 10% by weight of MgO, about 35% by weight of SiO₂ and about 12% by weight of Al₂O₃.

Electrothermal phosphorous slag is a waste product of electrothermal phosphorous production. It is less reactive than blast furnace slag and comprises about 45 to 50% by weight of CaO, about 0.5 to 3% by weight of MgO, about 38 to 43% by weight of SiO₂, about 2 to 5% by weight of Al₂O₃ and about 0.2 to 3% by weight of Fe₂O₃, and also fluoride and phosphate. Steel slag is a waste product of various steel production processes with greatly varying composition.

Amorphous silica is preferably an X ray-amorphous silica, i.e. a silica for which the powder diffraction method reveals no crystallinity. The content of SiO₂ in the amorphous silica of the invention is advantageously at least 80% by weight, preferably at least 90% by weight. Precipitated silica is obtained on an industrial scale by way of precipitating processes starting from water glass. Precipitated silica from some production processes is also called silica gel.

Fumed silica is produced via reaction of chlorosilanes, for example silicon tetrachloride, in a hydrogen/oxygen flame. Fumed silica is an amorphous SiO₂ powder of particle diameter from 5 to 50 nm with specific surface area of from 50 to 600 m₂ g⁻¹.

Microsilica is a by-product of silicon production or ferrosilicon production, and likewise consists mostly of amorphous SiO₂ powder. The particles have diameters of the order of magnitude of 0.1 μm. Specific surface area is of the order of magnitude of from 10 to 30 m² g⁻¹.

Fly ash is produced inter alia during the combustion of coal in power stations. Class C fly ash (brown-coal fly ash) comprises according to WO 08/012438 about 10% by weight of CaO, whereas class F fly ash (hard-coal fly ash) comprises less than 8% by weight, preferably less than 4% by weight, and typically about 2% by weight of CaO.

Metakaolin is produced when kaolin is dehydrated. Whereas at from 100 to 200° C. kaolin releases physically bound water, at from 500 to 800° C. a dehydroxylation takes place, with collapse of the lattice structure and formation of metakaolin (Al₂Si₂O₇). Accordingly, pure metakaolin comprises about 54% by weight of SiO₂ and about 46% by weight of Al₂O₃.

For the purposes of the present invention, aluminosilicates are the abovementioned reactive compounds based on SiO₂ in conjunction with Al₂O₃ which harden in an aqueous alkali environment. It is of course not essential here that silicon and aluminium are present in oxidic form, as is the case by way of example in Al₂Si₂O₇. However, for the purposes of quantitative chemical analysis of aluminosilicates it is usual to state the proportions of silicon and aluminium in oxidic form (i.e. as “SiO₂” and “Al₂O₃”).

A particularly suitable latent hydraulic binder is blast furnace slag.

The latent hydraulic binder is, in general, comprised in an amount in the range from about 1 to about 30 wt %, based on the weight of the aluminate-containing cement.

In case construction material composition contain low amount of hydraulic binder (e.g. 10%) an alkaline activator can be further added to promote strength development. Alkaline activators are preferably used in the binder system, such alkaline activators are for example aqueous solutions of alkali metal fluorides, alkali metal hydroxides, alkali metal aluminates or alkali metal silicates, such as soluble waterglass, and mixtures thereof.

The construction chemical compositions or building material formulations may also contain a calcium sulfate based binder.

In one preferred embodiment, the inorganic binder is a calcium sulfate based binder, which is selected from calcium sulfate dihydrate, calcium sulfate hemihydrate, anhydrite, and mixtures thereof.

The construction material composition can be for example concrete, mortar, cement paste or grouts. The term “cement paste” denotes the inorganic binder composition admixed with water.

The term “mortar” or “grout” denotes a cement paste to which are added fine granulates, i.e. granulates whose diameter is between 150 μm and 5 mm (for example sand), and optionally very fine granulates. A grout is a mixture of sufficiently low viscosity for filling in voids or gaps. Mortar viscosity is high enough to support not only the mortar's own weight but also that of masonry placed above it. The term “concrete” denotes a mortar to which are added coarse granulates, i.e. granulates with a diameter of greater than 5 mm.

The aggregate in this invention can be for example silica, quartz, sand, crushed marble, glass spheres, granite, limestone, sandstone, calcite, marble, serpentine, travertine, dolomite, feldspar, gneiss, alluvial sands, any other durable aggregate, and mixtures thereof. The aggregates are often also called fillers and in particular do not work as a binder.

The present invention further relates to a process for producing a construction material 3D structure comprising the steps of
(i) mixing component A of the additive kit as defined above with a construction material composition as defined above, water, and optionally further components; and
(ii) hardening the mixture of step (i) by adding component B of the additive kit as defined above.

It is to be understood that according to the process of the present invention, layers of material may be applied layer by layer being positioned under control of a computer. In this connection the term “layer by layer” refers to a repetitive process sequence, comprising the steps of dispensing the components according to steps (i) and (ii), followed by curing said dispensed layer. These steps are repeated so as to sequentially from a plurality of layers in a configured pattern corresponding to the shape of the desired object.

In one preferred embodiment, the present invention relates to a process for producing a construction material 3D structure comprising the steps of
(i) mixing component A of the additive kit as defined above with a construction material composition as defined above, water, and optionally further components; and
(ii) hardening the mixture of step (i) by adding component B of the additive kit as defined above, wherein
   layers of material are positioned under control of a computer.

In a preferred embodiment, in step (ii) of the process, component B is added to the mixture of step (i) during the application of the mixture with a 3D printing system, preferably by dosing it to the mixture on the printer nozzle.

Moreover, the present invention relates to a construction material 3D structure obtainable by the above defined process.

The present invention is further illustrated by the following examples.

### EXAMPLES

Preparation of a bisulfite adduct of glyoxylic acid:

148 g glyoxylic acid hydrate (50% in water) were charged into a reaction vessel and mixed with 594 g ethanol. 380 g sodium pyrosulfite (Na₂S₂O₅) dissolved in 750g of water were then added to the mixture. After stirring for 4 h the obtained suspension was cooled to 120 C. and allowed to stand for 24 h. The product crystallized and was isolated and dried. It was characterized by means of NMR.

Component A of an additive kit (hardening retarder):

53% by weight sodium carbonate

43% by weight bisulfite adduct of glyoxylic acid

4% trisodium citrate dihydrate

Citric acid is used as an alternative hardening retarder in reference examples 3 and 4.

Component B of an additive kit (hardening accelerator):

Ca(OH)₂ and/or C—S—H and/or glycerol are used in amounts as indicated for each mortar composition (will be dosed to the mortar mixture on the printer nozzle)

The following mortar compositions have been tested.

TABLE 1

| | Ref. 1 | | Ref. 2 | | Ex. 1 | | Ex. 2 | | Ref. 3 | | Ref. 4 | |
|---|---|---|---|---|---|---|---|---|---|---|---|---|
| OPC CEM I 42.5 (Karls-tadt) | 335 | g | 335 | g | 335 | g | 335 | g | 335 | g | 335 | g |
| Limestone powder | 30 | g | 30 | g | 30 | g | 30 | g | 30 | g | 30 | g |
| Micro silica | 15 | g | 15 | g | 15 | g | 15 | g | 15 | g | 15 | g |
| Fly ash | 30 | g | 30 | g | 30 | g | 30 | g | 30 | g | 30 | g |
| Dispersant based on a | 0.5 | g | 0.5 | g | 0.5 | g | 0.5 | g | 0.5 | g | 0.5 | g |
| polycarboxylate ether | | | | | | | | | | | | |
| (Melflux ® 4930 F) | | | | | | | | | | | | |
| Defoamer on the basis of | 0.5 | g | 0.5 | g | 0.5 | g | 0.5 | g | 0.5 | g | 0.5 | g |
| silicone and ethoxylated | | | | | | | | | | | | |
| fatty alcohol | | | | | | | | | | | | |
| (Vinapor ® DF 9010 F) | | | | | | | | | | | | |
| Internal water storage ad- | 2 | g | 2 | g | 2 | g | 2 | g | 2 | g | 2 | g |
| ditive based on salt insen- | | | | | | | | | | | | |
| sitive superabsorbent | | | | | | | | | | | | |
| technology based on | | | | | | | | | | | | |
| crosslinked acrylamide | | | | | | | | | | | | |
| polymer (Starvis ® S 3911 F) | | | | | | | | | | | | |
| Thickener based on | 0.1 | g | 0.1 | g | 0.1 | g | 0.1 | g | 0.1 | g | 0.1 | g |
| acrylamide based thick- | | | | | | | | | | | | |
| ener (Starvis ® T 50) | | | | | | | | | | | | |
| Quartz Sand (0.6-1.2 mm) | 267 | g | 267 | g | 267 | g | 267 | g | 267 | g | 267 | g |
| Quartz Sand (0.2-0.6 mm) | 120 | g | 120 | g | 120 | g | 120 | g | 120 | g | 120 | g |
| Quartz Sand (0.09-0.4 mm) | 200 | g | 200 | g | 200 | g | 200 | g | 200 | g | 200 | g |
| Water | 240 | g | 240 | g | 240 | g | 240 | g | 240 | g | 240 | g |

| | | | | | | | | | |
|---|---|---|---|---|---|---|---|---|---|
| Component A | — | 6 | g | 6 | g | 6 | g | — | — |

| | | | | | | | |
|---|---|---|---|---|---|---|---|
| Citric acid | — | — | — | 1 | g | 1 | g |

| Ca(OH)₂ | — | — | 50 | g | 50 | g | — | 50 | g |
|---|---|---|---|---|---|---|---|---|---|
| C—S—H | — | — | — | | 6 | g | — | 6 | g |
| Glycerol | — | — | 1.5 | g | 1.5 | g | — | 1.5 | g |

Results:
Ref. 1: 1 hour open time, afterwards the mortar can no longer be pumped and extruded. Hard-ening completed after 2 hours.
Ref. 2: 45 min open time, afterwards the mortar can no longer be pumped and extruded. Hard-ening completed after 2 hours.
Ex. 1: After addition of Ca(OH)₂ and glycerol, hardening is completed within only 15 minutes.
Ex. 2: After addition of Ca(OH)₂, C—S—H, and glycerol, hardening is completed within only 10 minutes.
Ref. 3: >2 hours open time.
Ref. 4: Hardening cannot be completed within <45 minutes.

The results show that the additive kit according to the invention based on component A and component B provides suitable properties for 3D printing regarding hardening retardation in the beginning and hardening acceleration after application with the 3D printer. It is noted that the additional additives used in the above examples, i.e. the dispersant, defoamer, internal water storage additive and the thickener, are not mandatorily required for the effective use of the additive kit according to the invention.

1.-15. (canceled)

16. A composition comprising an additive kit comprising a component A and a component B, wherein
component A comprises at least one hardening retarder selected from glyoxylic acid, salts thereof, condensation or addition products of glyoxylic acid or salts thereof, and mixtures thereof; and
component B comprises at least one hardening accelerator selected from calcium-silicate-hydrate, calcium carbonate, calcium amidosulfonate, calcium acetate, calcium citrate, calcium formate, calcium nitrate, calcium chloride, calcium hydroxide, lithium carbonate, lithium sulfate, potassium sulfate, sodium sulfate, ground gypsum, aluminium salts, slurries of aluminate cements, and combinations thereof;
where the composition is a construction material composition for 3D printing.

17. The composition according to claim 16, wherein the hardening retarder is selected from 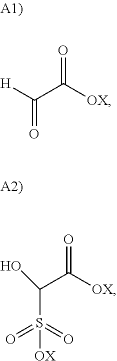
and
A3) an amine-glyoxylic acid condensate selected from the group consisting of a melamine-glyoxylic acid condensate, an urea-glyoxylic acid condensate, a melamine-urea-glyoxylic acid condensate and a polyacrylamide-glyoxylic acid condensate;
and mixtures thereof;
wherein X is in each case independently selected from H or a cation equivalent Kₐ, wherein K is an alkali metal, alkaline earth metal, zinc, iron, aluminium, ammonium, or a phosphonium cation, and wherein a is 1/n, wherein n is the valence of the cation.

18. The composition according to claim 17, wherein X is H, Na, K, Li or a mixture thereof.

19. The composition according to claim 16, wherein component A further comprises at least one carbonate source.

20. The composition according to claim 31, wherein the inorganic carbonate is selected from the group consisting of potassium carbonate, sodium carbonate, lithium carbonate, magnesium carbonate, and combinations thereof.

21. The composition according to claim 16 wherein component A further comprises at least one hydroxylic acid or a salt or hydrate thereof.

22. The composition according to claim 21, wherein the hydroxylic acid or salt thereof is selected from the group consisting of citric acid, tartaric acid, gluconic acid, salts, hydrates, and combinations thereof.

23. The composition according to claim 16, wherein the at least one hardening accelerator is selected from the group consisting of calcium-silicate-hydrate, calcium hydroxide, and combinations thereof.

24. The composition according to claim 16, wherein component B further comprises at least one polyhydroxy compound or salts or esters thereof.

25. The composition according to claim 24, wherein the polyhydroxy compound is selected from sugar alkohols and their condensation products, alkanolamines and their condensation products, carbohydrates, pentaerythritol, trimethylolpropane, and combinations thereof.

26. The composition according to claim 16, wherein the construction material composition comprises at least one inorganic binder.

27. The composition according to claim 26, wherein the at least one inorganic binder is a hydraulic binder.

28. A process for producing a construction material 3D structure comprising the steps of
(i) mixing component A of the additive kit as defined in claim 16 with a construction material composition as defined in claim 16, water, and optionally further components; and
(ii) hardening the mixture of step (i) by adding component B of the additive kit as defined in claim 16.

29. The process according to claim 28, wherein, in step (ii) of the process, component B is added to the mixture of step (i) during the application of the mixture with a 3D printing system.

30. A construction material 3D structure obtained by the process according to claim 28.

31. The composition according to claim 16, wherein component A further comprises at least one inorganic carbonate source.

32. The composition according to claim 21, wherein the hydroxylic acid or salt thereof is trisodium citrate or a hydrate thereof.

33. The composition according to claim 24, wherein the polyhydroxy compound is glycerol.

34. The composition according to claim 26, wherein the at least one inorganic binder is selected from the group consisting of Portland cement, calcium aluminate cement, sulfoaluminate cement, and mixtures thereof.

35. The composition according to claim 26, wherein the at least one inorganic binder is Portland cement.
